(19) United States
(12) Patent Application Publication
(10) Pub. No.: US 2004/0209066 A1
(43) Pub. Date: Oct. 21, 2004

(54) Polishing pad with window for planarization

(76) Inventors: Robert G. Swisher, Pittsburgh, PA (US); Alan E. Wang, Gibsonia, PA (US); William C. Allison, Murrysville, PA (US)

Correspondence Address: PPG Industries, Inc., Law - Intellectual Property - 39th Flr., One PPG Place, Pittsburgh, PA, 15272, US

(21) Appl. No.: 10/417,738

(22) Filed: Apr. 17, 2003

(51) Int. Cl. B32B 3/00

(52) U.S. Cl. 428/313.5

(57) ABSTRACT

The present invention relates to a polishing pad. In particular, the polishing pad of the present invention can include a window area. The window area can be formed in the pad using a cast-in-place process. The polishing pad of the present invention can be useful for polishing articles and can be especially useful for chemical mechanical polishing or planarization of a microelectronic device, such as a semiconductor wafer. The window area of the polishing pad of the present invention can be particularly useful for polishing or planarizing tools that are equipped with through-the-platen wafer metrology.

The present invention relates to a polishing pad. In particular, the polishing pad of the present invention can include a window area. The window area can be formed in the pad using a cast-in-place process. The polishing pad of the present invention can be useful for polishing articles and can be especially useful for chemical mechanical polishing or planarization of a microelectronic device, such as a semiconductor wafer. The window area of the polishing pad of the present invention can be particularly useful for polishing or planarizing tools that are equipped with through-the-platen wafer metrology.

The polishing or planarization of a non-planar surface of a microelectronic device to an essentially planar surface generally involves rubbing the non-planar surface with the work surface of a polishing pad using a controlled and repetitive motion. Typically, a polishing fluid is interposed between the rough surface of the article that is to be polished and the work surface of the polishing pad.

The fabrication of a microelectronic device such as a semiconductor wafer typically involves the formation of a plurality of integrated circuits on the wafer comprising, for example, silicon or gallium arsenide. The integrated circuits are generally formed by a series of process steps in which patterned layers of materials, such as conductive, insulating and semiconducting materials, are formed on the substrate. In order to maximize the density of integrated circuits per wafer, it is desirable to have an extremely planar precision polished substrate at various stages throughout the semiconductor wafer production process. Thus, semiconductor wafer production typically includes at least one, and more typically a plurality of polishing steps, which can use one or more polishing pads.

In a typical chemical mechanical polishing (CMP) process, the microelectronic substrate is placed in contact with a polishing pad. The pad is rotated while a force is applied to the backside of the microelectronic device. An abrasive-containing chemically-reactive solution commonly referred to as a “slurry” is applied to the pad during polishing. Typically, CMP polishing slurries contain an abrasive material, such as silica, alumina, ceria or mixtures thereof. The polishing process is facilitated by the rotational movement of the pad relative to the substrate as slurry is provided to the device/pad interface. Polishing is continued in this manner until the desired film thickness is removed.

Depending on the choice of polishing pad and abrasive, and other additives, the CMP process may provide effective polishing at desired polishing rates while minimizing surface imperfections, defects, corrosion, and erosion.

There are planarizing tools known in the art which have the ability to measure the progress of the planarization process while the wafer is held in the tool and in contact with the pad. The ability to measure the progress of planarizing a microelectronic device during the planarizing process can be referred to as “in-situ metrology”. U.S. Pat. Nos. 5,964,643 and 6,159,073; and European Patent 1,108,501 describe polishing or planarizing tools and in-situ metrology systems. In general, in-situ metrology can include directing a beam of light through an at least partially transparent area or window located in the platen of the tool; the beam of light can be reflected off the surface of the wafer, back through the platen window, and into a detector. The polishing pad useful with in-situ metrology systems, includes a window area that is at least partially transparent to the wavelengths used in the metrology system, and essentially aligned with the platen window of the tool.

It is desirable to develop a polishing pad that comprises a window area useful for in-situ metrology.

The present invention includes a polishing pad having a window. The window can be formed by a cast-in-place process. The polishing pad can comprise at least a first layer and a second layer. The first layer can function as the work surface or polishing layer of the pad. The second layer can be at least partially connected to the first layer. At least a portion of the first layer and at least a portion of the second layer can comprise an opening which extends at least substantially through the thickness of the layers. At least a portion of the opening in the first layer can be at least partially aligned with at least a portion of the opening in the second layer. An at least partially transparent window can be formed in at least a portion of the opening using a cast-in-place process. In a non-limiting embodiment, the window area can be at least partially transparent to the wavelengths used by metrology instrumentation known in the art. In a non-limiting embodiment, the window area can be substantially transparent. In another non-limiting embodiment, the window area can be essentially flush with the polishing surface of the first layer.

In a non-limiting embodiment, the polishing pad of the present invention can comprise additional layers. Each additional layer can contain an opening and the opening(s) can be substantially aligned with the opening of the first layer and the opening of the second layer. In a non-limiting embodiment, a polishing pad can have three layers, each layer having an opening therein and the openings can be at least partially aligned. The three layers can be at least partially connected (i.e., the first layer connected to at least a portion of the second layer, and the second layer connected to at least a portion of the third layer). A spacer can be inserted into the opening. In a non-limiting embodiment, the bottom surface of the spacer can be essentially flush with the outer surface (i.e., the surface that is not at least partially connected to the second layer) of the third layer. The opening remaining above the spacer can be filled with a resin material. In a non-limiting embodiment, the opening is filled such that the resin level is essentially flush with the polishing surface of the first layer. The resin material used to form the window of the pad can be allowed to cure; the cure time and temperature can vary. Generally, a cure time can be chosen such that the resin is not tacky or sticky to the touch. In general, a cure temperature can be chosen such that warp or deformation of the window which can be produced due to a cure temperature that is too low or too high does not render the pad inoperable for the purpose of polishing an object. In a non-limiting embodiment, the cure time can be from 30 minutes to 48 hours, or from 18 hours to 36 hours, or from 6 hours to 24 hours, or from 1 hour to 4 hours. In a non-limiting embodiment, the cure temperature can be from 0° C. to less than 125° C., or from 5° C. to 120° C., or from 10° C. to 115° C., or from 15° C. to 110° C., or from 22° C. to 105° C.

Depending on the material of which the spacer is constructed, the spacer can remain in the window area or it can be removed. In alternate non-limiting embodiments, the spacer can be constructed of a material that is at least partially transparent, or substantially transparent, or transparent to at least one wavelength from 190 to 3500 nanometers, and the spacer can remain in the window pad assembly. In another non-limiting embodiment, the spacer can be constructed of a material that may not be at least partially transparent, and the spacer can be removed. In a non-limiting embodiment of the invention, the spacer can be removed from the window area.

In another non-limiting embodiment, the spacer can be positioned such that it is not flush with the outer surface of the third layer.

It is noted that, as used in this specification, the singular forms “a,” “an,” and “the” include plural referents unless expressly and unequivocally limited to one referent.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The polishing pad of the present invention comprises a first layer which can function as the polishing layer of the pad. The first layer can provide a surface which can be in contact with the polishing fluid and the article to be polished. Non-limiting examples of suitable materials for the first layer can include particulate polymer and crosslinked polymer binder such as described in International Publication No. WO 02/22309; particulate polymer and an organic polymer binder; sintered particles of thermoplastic resin as described in U.S. Pat. Nos. 6,062,968; 6,117,000; and 6,126,532; and pressure sintered powder compacts of thermoplastic polymer as described in U.S. Pat. Nos. 6,231,434 B1, 6,325,703 B2, 6,106,754 and 6,017,265. Further non-limiting examples of suitable materials for the first layer include polymeric matrices impregnated with a plurality of polymeric microelements, wherein each polymeric microelement can have a void space within, as described in U.S. Pat. Nos. 5,900,164 and 5,578,362. The disclosure in the aforementioned patents and patent publications relevant to suitable materials for the first layer of the polishing pad of the present invention, are herein incorporated by reference.

The thickness of the first layer can be chosen from a wide variety of thicknesses. In general, the thickness of the first layer can be selected such that it can be aligned and properly mounted of the platen of the polishing tool, result in uniform polishing of an article, and an acceptable lifetime of the pad. If the first layer is too thick, it can be difficult to align and properly mount the pad and the pad can be too inflexible which can adversely impact the uniformity of the polishing process. If the first layer is too thin, the pad can be too flexible which can adversely impact the uniformity of the polishing process and the lifetime of the pad. In alternative non-limiting embodiments, the first layer can have a thickness of at least 0.020 inches, or at least 0.040 inches; or 0.150 inches or less, or 0.080 inches or less.

In a non-limiting embodiment, the first layer can be comprised of a material having pores such that polishing fluid can be at least partially absorbed by the first layer. The material comprising the first layer can have a porosity, expressed as percent pore volume, of at least two (2) percent by volume based on the total volume of the first layer. In alternative non-limiting embodiments, the first layer can have a porosity of 50 percent or less by volume based on the total volume of the first layer. The percent pore volume of the polishing pad can be determined using the following expression:

% pore volume=100×(density of the pad)×(pore volume of the pad)

wherein the density is expressed in units of grams per cubic centimeter, and can be determined in accordance with ASTM D 1622-88. The pore volume is expressed in units of cubic centimeters per gram, and can be determined by means of an Autopore III mercury porosimeter from Micromeritics, in accordance with the mercury porosimetry method recited in ASTM D 4284-88. In a non-limiting embodiment, the pore volume measurements can be made under the following conditions: a contact angle of 140°; a mercury surface tension of 480 dynes/cm; and degassing of the polishing pad sample under a vacuum of 50 micrometers of mercury.

In a non-limiting embodiment, the first layer can have at least a partially open cell structure such that it can absorb at least two (2) percent by weight of polishing fluid based on the total weight of said first layer. In alternate non-limiting embodiments, the first layer can absorb not more than 50 percent by weight, or from 2 percent by weight to 50 percent by weight. In a further non-limiting embodiment, the liquid absorbed by the pad can be the slurry used during a polishing or planarizing process.

The polishing pad of the present invention comprises a second layer. In a non-limiting embodiment, a second layer can be at least partially connected to the non-polishing surface of a first layer. Non-limiting examples of suitable materials for the second layer can include substantially non-compressible polymer and metallic films and foils. The second layer can comprise, for example, polyolefin, such as low density polyethylene, high density polyethylene ultra-high molecular weight polyethylene and polypropylene; polyvinylchloride; cellulose-based polymers, such as cellulose acetate and cellulose butyrate; acrylic; polyesters and co-polyesters, such as PET and PETG; polycarbonate; polyamide, such as nylon 6/6 and nylon 6/12; and high performance plastics, such as polyetheretherketone, polyphenylene oxide, polysulfone, polyimide, and polyetherimide. The second layer may comprise metallic films such as but not limited to aluminum, copper, brass, nickel, and stainless steel. In a non-limiting embodiment, the second layer can comprise double-coated film tape with release liner which can be commercially obtained from 3M as type 442 double-coated film tape.

The thickness of the second layer can be chosen from a wide variety of thicknesses. In alternate non-limiting embodiments, the second layer can have a thickness of at least 0.0005, or at least 0.0010; or 0.0650 inches or less, or 0.0030 inches or less.

In a non-limiting embodiment, the second layer can at least partially distribute the compressive forces experienced by the first layer over a larger area of a second layer. In a non-limiting embodiment, the second layer is substantially non-volume compressible. As used herein, the term “compressible” refers to the percent volume compressibility measurement, which can be measured using various methods known to the skilled artisan. A method for measuring percent volume compressibility is later described herein. If the pad is too compressible, the first layer of the pad can compress into the microscopic contours or short-term surface of the wafer. In alternate non-limiting embodiments, the compressibility of the polishing pad can be at least one (1) percent; or three (3) percent or less.

In another non-limiting embodiment, the flexibility of the second layer can be such that the first layer (e.g., the polishing layer of the pad) which can be at least partially connected to the second layer, can essentially conform to the macroscopic or long-term surface of the article being polished. In a non-limiting embodiment, a microelectronic device to be polished can have a surface which is not substantially planar as a result of the manufacturing process. The topography of the device (e.g., semiconductor wafer) can include a range of heights, which can at least partially resemble “waves”. The use of a polishing pad which can essentially conform to the “wave” surface of the wafer allows the polishing pad to substantially contact various heights of the surface, e.g, the peaks and valleys of the “wave(s)”, such that a substantial portion or essentially the entire surface of the wafer can be polished or planarized. The use of a polishing pad which cannot essentially conform to the “wave” surface of the wafer can result in polishing only the surface of the wafer that is in contact with the surface of the pad; e.g., the high points or the peaks of the wave(s); and the lower heights or the valleys of the wave(s) which cannot contact the polishing pad can remain unpolished or unplanarized.

As used herein the term “flexibility” (F) refers to the inverse relationship of the second layer thickness cubed (t³) and the flexural modulus of the second layer material (E), i.e. F=1/t³E. In a non-limiting embodiment, the flexibility of the second layer is greater than 1.0×10⁻⁸ in⁻¹lb⁻¹. In a further non-limiting embodiment, the flexibility is greater than 1.0×10⁻⁴ in⁻¹lb⁻¹.

At least a portion of the first and second layers comprise a window which is at least partially transparent to wavelengths used by the metrology instrumentation of the planarizing equipment. In a non-limiting embodiment, the window can be at least partially transparent to at least one wavelength in the range of from 190 to 3500 nanometers. In another non-limiting embodiment, the window of the pad can be at least partially transparent to the wavelength of the laser or light beam of the interferometer of the in-situ metrology device used.

In an embodiment of the present invention, an opening can be produced in the first layer and the second layer of the polishing pad. In alternate non-limiting embodiments, the opening in the first and second layers can be produced by any suitable means known in the art, such as punching, die cutting, laser cutting or water jet cutting. In a further non-limiting embodiment, the opening can be formed by molding the layer such that an opening can be formed. In alternate non-limiting embodiments, the opening can be produced in each layer prior to at least partially connecting the two layers or after the two layers have been at least partially connected. The opening can be of sufficient size and shape to accept a cast-in-place window area that is essentially aligned with the platen window of a polishing or planarizing tool and at least partially transparent to the wavelengths used in a metrology system of the tool. Thus, the size and shape of the opening and the resulting window can vary widely based on the type of polishing or planarizing tool employed. In alternate non-limiting embodiments, an opening can be die cut into the first layer and the second layer either prior to at least partially connecting the layers or after the layers have been at least partially connected, using an NAEF Model B die press fitted with dies of suitable size and shape, commercially available from MS Instruments Company, Stony Brook, N.Y.

The size, shape, and location of the opening in the first layer and second layer can be determined in accordance with the CMP equipment employed. In a non-limiting embodiment, a Mirra polisher, produced by Applied Materials Inc, Santa Clara Calif., can be use wherein the shape of the opening is a rectangle, having a size of 0.5″×2″, being positioned with the long axis radially oriented and centered 4″ from the center of the pad. The platen for the Mirra polisher is 20″ in diameter. A pad for use with this polisher can comprise a circle of a 20-inch diameter having a window area located in the area as described.

In a further non-limiting embodiment, a Teres polisher commercially available from Lam Research Corporation, Fremont, Calif., can be employed. This polisher uses a continuous belt instead of a circular platen. The pad for this polisher can be a continuous belt of 12″ width and 93.25″ circumference, which has a window area suitably sized and positioned to align with the metrology window of the Teres polisher.

In a non-limiting embodiment, an opening can be cut (e.g., die-cut) into the first and second layers of the polishing pad. The opening then can be sealed on the side of the second layer that is not at least partially connected to the first layer. The material used to seal-off the opening can be chosen from a wide variety of materials known in the art. Suitable materials can include but are not limited to adhesive materials such as adhesive tape. A spacer can be inserted into the opening. In non-limiting alternate embodiments, the spacer can be temporary and removed following formation of the window, or the spacer can be permanent and remain following formation of the window. The material, size and shape of the spacer can vary widely. In a non-limiting embodiment, the spacer can be constructed of a material that is at least partially transparent. In another non-limiting embodiment, the spacer can be constructed of polyester film. In general, the size and shape of the spacer can be such that it fits securely in the pad opening and at least partially contacts the material used to seal the opening. In a non-limiting embodiment, the spacer can at least partially attach to the material used to seal the opening. In a further non-limiting embodiment, an adhesive tape can be used to seal the opening and the spacer can be at least partially adhered to an adhesive portion of the tape.

Following insertion of the spacer, the opening positioned/remaining above the spacer can be filled with a resin material suitable for forming a pad window. In a non-limiting embodiment, the resin can be poured into the opening above the spacer such that the introduction of air voids into the resin is minimized. In another non-limiting embodiment, the amount of resin used can be such that the resin level is flush with the polishing surface of the pad.

In a non-limiting embodiment, the resin material can be selected such that the resulting window formed can be at least partially transparent to the wavelengths of the in-situ metrology instrumentation of a polishing apparatus. In a further non-limiting embodiment, the window formed can be substantially transparent. Suitable resin materials can comprise materials known to one having ordinary skill in the art that either is at least partially transparent or can be made at least partially transparent. Non-limiting examples of resin materials for use in the present invention can include but are not limited to polyurethane prepolymers with curative, epoxy resins with curative, ultraviolet curable acrylics, and mixtures thereof. Non-limiting examples of suitable materials for the resin can include thermoplastic acrylic resins, thermoset acrylic resins, such as hydroxyl-functional acrylic resins crosslinked with urea-formaldehyde or melamine-formaldehyde resins, hydroxyl-functional acrylic resins crosslinked with epoxy resins, or carboxyfunctional acrylic resins crosslinked with carbodiimides or polyimines or epoxy resins; urethane systems, such as hydroxyfunctional acrylic resin crosslinked with polyisocyanate; diamine cured isocyanate-terminated prepolymers; isocyanate-terminated prepolymers crosslinked with polyamines; amine-terminated resins crosslinked with polyisocyanates; carbamate-funtional acrylic resins crosslinked with melamine-formaldehyde resins; epoxy resins, such as polyamide resin crosslinked with bisphenol A epoxy resins, phenolic resins crosslinked with bisphenol A epoxy resins; polyester resins, such as hydroxyl-terminated polyesters crosslinked with melamine-formaldehyde resins or with polyisocyanates or with epoxy crosslinkers, and mixtures thereof.

In a non-limiting embodiment, the resin material can comprise amine-terminated oligomer such as VERSALINK P650 which is commercially available from Air Products and Chemicals, Inc., diamine such as LONZACURE MCDEA which is commercially available from Air Products and Chemicals, Inc., and polyisocyanate such as DESMODUR N 3300 A which is commercially available from Bayer Corporation Coatings and Colorants Division.

In alternate non-limiting embodiments, the resin material for use in the present invention can include various conventional additives known in the art. Non-limiting examples of such additives can include but are not limited to light stabilizers, antioxidants, dyes, processing aids such as but not limited to wetting agents, defoamers, and degassing aids such as but not limited to silicone surfactants, and mixtures thereof. In alternate non-limiting embodiments, commercially available silicone surfactants such as SAG-47 and COATSIL 3501 from OSi Specialties, and GE-SF 1080 from GE Silicones, can be added to the resin material. In general, the amount of additives used can vary widely depending on the particular resin material and the particular additive. In alternate non-limiting embodiments, additive(s) can be added in an amount such that additive(s) constitutes less than 10 percent by weight, or less than 5 percent by weight, or less than 3 percent by weight of the resin/additive mixture.

In a further non-limiting embodiment, the resin which can be used to form the window in the pad can be cured. The curing process can include allowing the pad containing the resin to set for a specified amount of time at a specified temperature. The time and temperature used to cure the window resin can vary widely and can depend on the resin material chosen to form the window. Generally, a cure time can be chosen such that the resin is not tacky or sticky to the touch. In general, a cure temperature can be chosen such that warp or deformation of the window which can be produced due to a cure temperature that is too low or too high does not render the pad inoperable for the purpose of polishing an object. In a non-limiting embodiment, the cure time can be from 30 minutes to 48 hours, or from 18 hours to 36 hours, or from 6 hours to 24 hours, or from 1 hour to 4 hours. In a non-limiting embodiment, the cure temperature can be from 0° C. to less than 125° C., or from 5° C. to 120° C., or from 10° C. to 115° C., or from 15° C. to 110° C., or from 22° C. to 105° C.

Following the curing step, the spacer and the adhesive tape which was used to seal the opening, can be removed. In an alternate non-limiting embodiment, following the curing step, only the adhesive tape can be removed. In a non-limiting embodiment, the resulting window area can be made coplanar with the pad work surface using a milling machine.

In a non-limiting embodiment, a third layer can be at least partially connected to the second layer of the polishing pad of the present invention. In a further non-limiting embodiment, one surface of the third layer can be at least partially connected to the second layer and the other parallel surface of the third layer can contain an adhesive such that the third layer can be at least partially connected to the base of the planarizing machine. The third layer can be referred to in the art as a subpad. In a further non-limiting embodiment, an opening can be produced in the third layer and the adhesive layer which can at least partially connect the third layer to the base of the planarizing machine. In alternate non-limiting embodiments, the opening can be produced in the first, second and third layers either prior to or following at least partially connecting the first layer to the second layer and the second layer to the third layer. The opening can be at least partially aligned with the opening in the first layer and the opening in the second layer. The opening can be produced using various methods as previously described herein, and the shape and size of the opening can vary depending on the polishing tool employed as previously described herein. In a further non-limiting embodiment, a spacer can be placed in the opening, and the opening can be filled with a resin material and cured to form a cast-in-place window in the pad using the conditions and process as previously described herein.

In a non-limiting embodiment, the third layer can be used to increase the uniformity of contact between the polishing pad and the surface of the substrate undergoing polishing. A consideration in selecting the material for the third layer can be whether the material can provide compliant support to the work surface (e.g., the first layer) of the polishing pad such that the polishing layer essentially conforms to the macroscopic contour or long-term surface of the microelectronic device being polished.

The thickness of the third layer can be chosen from a variety of thicknesses. The thickness can be selected such that the resultant pad can be properly mounted on the platen of a polishing tool. Further, the thickness of the third layer can be selected such that it can provide compliant support to the work surface (e.g., the first layer) of the polishing pad to the extent that the polishing layer can essentially conform to the macroscopic contour or long-term surface of the microelectronic device being polished. A third layer that is too thick can result in excessive pad compliance which can adversely impact polishing uniformity; a third layer that is too thin can provide compliant support to the work surface which is insufficient and can adversely impact polishing performance by not allowing the polishing layer to essentially conform to the macroscopic/long-term surface of the device being polished. In a non-limiting embodiment of the present invention, the third layer can be at least 0.020 inches thick. Thus, in alternate non-limiting embodiments, the thickness of the third layer can be at least 0.040 inches, or at least 0.045 inches; or 0.100 inches or less, or 0.080 inches or less, or 0.065 inches or less.

Suitable materials for the third layer can include but are not limited to non-woven or woven fiber mat, i.e. polyolefin, polyester, polyamide, or acrylic fibers, which have been impregnated with a resin. The fibers can be staple or substantially continuous in the fiber mat. Non-limiting examples include non-woven fabric impregnated with polyurethane as describe in U.S. Pat. No. 4,728,552, i.e. polyurethane impregnated felt. A non-limiting example of a commercially available non-woven sub-pad layer can be Suba™ IV, from Rodel, Inc. Newark Del.

In a further non-limiting embodiment, the polishing pad of the present invention can include a third layer which can comprise natural rubber, synthetic rubbers, thermoplastic elastomer, or essentially resilient foam sheet. The material of the third layer can be foamed or blown to produce a porous structure. The porous structure can be open cell, closed cell, or combinations thereof. Non-limiting examples of synthetic rubbers include neoprene rubber, silicone rubber, chloroprene rubber, ethylene-propylene rubber, butyl rubber, polybutadiene rubber, polyisoprene rubber, EPDM polymers, styrene-butadiene copolymers, copolymers of ethylene and ethyl vinyl acetate, neoprene/vinyl nitrile rubber, and neoprene/EPDM/SBR rubber. Non-limiting examples of thermoplastic elastomers include polyolefins, polyesters, polyamides, polyurethanes such as those based on polyethers and polyesters, and copolymers thereof. Non-limiting examples of foam sheet which can be used for the third layer include ethylene vinyl acetate sheets, such as those which are commercially available from Acor Orthopedic Inc., Cleveland, Ohio; ethylene vinyl acetate sheets and polyethylene foam sheets, such as those which are commercially available from Sentinel Products, Hyannis, N.J.; polyurethane foam sheets, such as those which are commercially available from Illbruck, Inc., Minneapolis, Minn.; and polyurethane foam sheets, such as those which are available from Rogers Corporation, Woodstock, Conn. under the trade name PORON.

In a non-limiting embodiment, the third layer can comprise a material that is softer than the polishing layer (e.g., first layer). As used herein, the term “softness” refers to the Shore A Hardness of the material. The softer the material, the lower the Shore A Hardness value. In the present invention, the Shore A Hardness value of the third layer can be lower than the Shore A Hardness value of the first layer. In a non-limiting embodiment, the third layer can have a Shore A Hardness of at least 15. In alternate non-limiting embodiments, the Shore A Hardness of the third layer can be at least 45, or 75 or less, or from 45 to 75. The Shore A Hardness of the first layer can be at least 85. In alternate non-limiting embodiments, the Shore A Hardness of the first layer can be 100 or less, or from 85 to 100. Shore A Hardness can be determined using a variety of instrumentation and methods known to one having ordinary skill in the art. In the present invention, Shore A Hardness can be measured using a Shore “Type A” Durometer having a maximum indicator (available from The Shore Instrument & MFG. Co., Inc., New York, N.Y.), in accordance with the procedure recited in ASTM D 2240. The test method for Shore Hardness includes the penetration of a particular type of indentor being forced into the material under specified conditions. The hardness can be described as inversely related to the penetration depth and the hardness can be dependent on the elastic modulus and viscoelastic behavior of the material tested.

In a non-limiting embodiment of the present invention, the material comprising the third layer of the polishing pad can demonstrate a compressibility that is greater than the compressibility of the material comprising the first layer. As used herein, the term “compressibility” refers to the percent volume compressibility measurement. Thus, the percent volume compressibility of the third layer is greater than the percent volume compressibility of the first layer. In a non-limiting embodiment, the percent volume compressibility of the third layer can be less than 20 percent when a load of 20 psi is applied. In a further non-limiting embodiment, the percent volume compressibility of the third layer can be less than 10 percent when a load of 20 psi is applied, or less than 5 percent when a load of 20 psi is applied. In alternate non-limiting embodiments, the percent volume compressibility of the first layer can be less than the percent volume compressibility of the third layer, or from 0.3 to 3 percent when a load of 20 psi is applied. The percent volume compressibility of the third layer can be determined using a variety of instruments and methods known to one having ordinary skill in the art. In a non-limiting embodiment of the present invention, the percent volume compressibility of a layer of the polishing pad or of the polishing pad can be calculated using the following expression:

$$100 \times \frac{( pad volume without load - pad volume under load )}{( pad volume without load )}$$

If the area of the pad does not change when the load (e.g., 20 psi) is placed on it, then the preceding equation for volume compressibility may be expressed in terms of pad thickness by the following expression.

$$100 \times \frac{( pad thickness without load - pad thickness under load )}{( pad thickness without load )}$$

In a non-limiting embodiment, the pad thickness can generally be determined by placing a load (e.g., calibrated weights) on the pad sample and measuring the change in thickness of the pad as a result of the load. In the present invention, a Mitutoyo Electronic Indicator, Model ID-C112EB can be used. The indicator has a spindle or threaded rod which can be fitted at one end with a flat contact under which the pad is placed. The spindle can be fitted at the other end with a device for applying specified loads to the contact area, such as a balance pan which accepts calibrated weights. The Indicator displays the displacement of the pad resulting from applying the load. The Indicater display is typically representative of inches or millimeters. The Electronic Indicator can be mounted on a Mitutoyo Precision Granite Stand to provide stability while taking the measurements. The lateral dimensions of the pad can be sufficient to permit measurements at least 0.5″ from any edge. The surface of the pad can be flat and parallel over a sufficient area to permit uniform contact between the test pad and the flat contact. The pad to be tested can be placed under the flat contact. The thickness of the pad can be measured prior to applying the load. Calibrated balance weights can then be added to the balance pan for a specific resultant load. The pad is then compressed under the specified load. The Indicator can display the thickness/height of the pad under the specified load. The thickness of the pad prior to applying the load minus the thickness of the pad under the specified load can be used to determine the displacement of the pad. In a non-limiting embodiment, a load of 20 psi can be applied to the pad. Measurements can be made at a standardized temperature such as room temperature. In general, measurements can be made at a temperature of 22° C. +/−2° C. This method of measuring thickness can be applicable to a pad sample or to a pad layer sample.

In a non-limiting embodiment, a procedure for measuring percent volume compressibility can include placing the contact on the granite base and adjusting the indicator to read zero. The contact can then be raised and the specimen placed on the granite stand under the contact with the edge of the contact at least 0.5″ from any edge of the specimen. The contact can be lowered onto the specimen and the specimen thickness measurement can be taken after 5+/−1 seconds. Without moving the specimen or the contact, sufficient weight can be added to the pan to cause a force of 20 psi to be applied to the specimen by the contact. The reading for the specimen thickness under load measurement can be made after 15+/−1 seconds. The measurement procedure can be repeated, making five measurements at different positions on the specimen at least 0.25″ apart using 20 psi of compressive force.

In a non-limiting embodiment, the polishing pad of the present invention can include a first layer at least partially connected to a second layer, and the second layer at least partially connected to a third layer. The second layer of the polishing pad can act as a barrier to fluid transport between the first layer and the third layer. Thus, a consideration in selecting the material comprising the second layer can be the ability of the material to prevent the transport of polishing fluid from the first layer into the third layer. In a non-limiting embodiment, the second layer can be comprised of a material which is essentially impermeable to the polishing fluid such that the third layer does not become substantially saturated with polishing fluid.

In a non-limiting embodiment, the first layer, second layer and optional third layer of the polishing pad of the present invention can be at least partially connected; and an opening can be produced in each layer either prior to or after the layers are at least partially connected to one another. The opening in the first, second and third layers can be at least partially aligned with one another and at least partially aligned with the platen window of a polishing or planarizing tool.

In another non-limiting embodiment, a three-layer pad can be constructed by at least partially connecting a first layer (i.e., polishing layer) to a second layer and at least partially connecting the second layer to a third layer (i.e., base or subpad).

In a further non-limiting embodiment, a 22.0″ diameter SUBA IV subpad commercially available from Rodel, Incorporated can comprise the third layer. A window opening can be cut into the first, second and third layers as described previously herein. In a further non-limiting embodiment, the opening can be rectangular in shape, having dimensions of 0.5″×2.0″, being positioned with the long axis radially oriented and centered 4″ from the center of the pad. In alternate non-limiting embodiments, the opening can be cut into the SUBA IV pad prior to at least partially connecting it to the second layer, or the opening can be cut following at least partially connecting the first, second and third layers. In a non-limiting embodiment, the first layer can be at least partially connected to the second layer, an opening can be cut into the first and second layer assembly, the release liner of the second layer can be removed, and the exposed adhesive can be used to at least partially connect the second layer to the SUBA IV subpad. An opening can be cut into the subpad prior to or after at least partially connecting the subpad to the first and second layer pad assembly. The opening in the subpad can be at least partially aligned with the opening in the first and second layers. A spacer can be inserted into the opening of the assembly, and the opening above the spacer can be filled with resin to form a window as previously described herein.

In another non-limiting embodiment, the window can be formed in the first and second layer assembly as previously described herein, and the third layer containing an opening then can be at least partially connected to the first and second layer assembly such that the opening in the third layer is at least partially aligned with the window in the first and second layer assembly.

In a non-limiting embodiment, the first layer of the polishing pad can be connected to at least a portion of the second layer using an adhesive. In an alternate non-limiting embodiments, the first layer of the polishing pad can be connected to at least a portion of the second layer and the second layer can be connected to at least a portion of the third layer using an adhesive. A suitable adhesive for use in the present invention can provide sufficient peel resistance such that the pad layers essentially remain in place during use. Further, a suitable adhesive for use in the present invention can at least substantially withstand shear stresses which are present during the polishing or planarization process and moreover, can at least substantially resist chemical and moisture degradation during use. The adhesive can be at least partially applied using conventional techniques known to the skilled artisan. In alternate non-limiting embodiments, the adhesive can be at least partially applied to the lower surface of the first layer and the upper surface of the second layer; and/or the adhesive can be at least partially applied to the lower surface of the second layer and the upper surface of the third layer.

The adhesive can be chosen from a wide variety of adhesive materials known in the art, such as but not limited to contact adhesives, pressure sensitive adhesives, structural adhesives, hot melt adhesives, thermoplastic adhesives, and curable adhesives, such as thermosetting adhesives. Non-limiting examples of suitable structural adhesives can be chosen from polyurethane adhesives, and epoxy resin adhesives; such as those based on the diglycidyl ether of bisphenol A. Non-limiting examples of suitable pressure sensitive adhesives can include an elastomeric polymer and a tackifying resin. Suitable elastomeric polymers can be chosen from natural rubber, butyl rubber, chlorinated rubber, polyisobutylene, poly(vinyl alkyl ethers), alkyd adhesives, acrylics such as those based on copolymers of 2-ethylhexyl acrylate and acrylic acid, block copolymers such as styrene-butadiene-styrene, and mixtures thereof.

In a non-limiting embodiment, a pressure sensitive adhesive can be applied to a substrate using an organic solvent such as toluene or hexane, or from a water-based emulsion or from a melt. As used herein, “hot melt adhesive” refers to an adhesive comprising a nonvolatile thermoplastic material that can be heated to a melt, then at least partially applied to a substrate as a liquid. Non-limiting examples of suitable hot melt adhesives can be chosen from ethylene-vinyl acetate copolymers, styrene-butadiene copolymers, ethylene-ethyl acrylate copolymers, polyesters, polyamides such as those formed from the reaction of a diamine and a dimer acid, and polyurethanes.

In a non-limiting embodiment, the second layer can comprise an adhesive assembly. The adhesive assembly can include an intermediate layer at least partially interposed between an upper adhesive layer and a lower adhesive layer. In a further non-limiting embodiment, the upper adhesive layer of the adhesive assembly can be at least partially connected to the lower surface of the first layer, and the lower adhesive layer of the adhesive assembly can be at least partially connected to the upper surface of the third layer. The intermediate layer of the adhesive assembly can be selected from the aforementioned suitable materials for the second layer of the polishing pad. The upper and lower adhesive layers of the adhesive assembly can be selected from the non-limiting examples of adhesives previously mentioned herein. In a non-limiting embodiment, the upper and lower adhesive layers each can be contact adhesives. The adhesive assembly can be referred to in the art as two-sided or double-coated tape. Non-limiting examples of suitable adhesive assemblies can include those commercially available from 3M, Industrial Tape and Specialties Division.

In non-limiting embodiment, the polishing pad of the present invention can comprise a first layer, a second layer, and a third layer, wherein each layer can comprise an opening. The opening of the first, second and third layers can be at least partially aligned. A cast-in-place window can be formed within the opening using the method previously described herein.

In an alternate non-limiting embodiments, a coating can be at least partially applied to the top and/or bottom surfaces of the window area of the polishing pad. The coating can provide any one of the following properties, for example: improved transparency of the window area, improved abrasion resistance, improved puncture resistance, and/or anti-reflective properties. The coating can comprise the materials recited previously for use in the second layer of the polishing pad. In a non-limiting embodiment, the coating can be a cast-in-place resin coating, which can be applied as a liquid, as a solvent solution, dispersion, or aqueous latex; as a melt, or as a blend of resin precursors that can react to form the coating. The application of the liquid can be accomplished by a variety of known methods, including spraying, padding, and pouring. Non-limiting examples of suitable materials for the coating include thermoplastic acrylic resins, thermoset acrylic resins, such as hydroxyl-functional acrylic latexes crosslinked with urea-formaldehyde or melamine-formaldehyde resins, hydroxyl-functional acrylic resins crosslinked with epoxy resins, or carboxyfunctional acrylic latexes crosslinked with carbodiimides or polyimines or epoxy resins; urethane systems, such as hydroxyfunctional acrylic resin crosslinked with polyisocyanate, carbamate-funtional acrylic resins crosslinked with melamine-formaldehyde resins, diamine-cured isocyanate-terminated prepolymers; epoxy resins, such as polyamide resin crosslinked with bisphenol A epoxy resins, phenolic resins crosslinked with bisphenol A epoxy resins; polyester resins, such as hydroxyl-terminated polyesters crosslinked with melamine-formaldehyde resins or with polyisocyanates or with epoxy crosslinkers.

In a non-limiting embodiment, the coating can be an aqueous acrylic latex, which can be applied following stacking of the pad assembly. The coating can be applied to the top and bottom surfaces of the window area of the second layer. Application of the coating can be performed following removal of an adhesive tape and optionally spacer from the window area.

The polishing pad of the present invention can be used in combination with polishing fluids, such as polishing slurries, which are known in the art. Non-limiting examples of suitable slurries for use with the pad of the present invention, include but are not limited to the slurries disclosed in United States Patent Application having Ser. Nos. 09/882,548 and 09/882, 549, which were both filed on Jun. 14, 2001 and are pending. In a non-limiting embodiment, the polishing fluid can be interposed between the first layer of the pad and the substrate to be polished. The polishing or planarizing process can include moving the polishing pad relative to the substrate being polished. A variety of polishing fluids or slurries are known in the art. Non-limiting examples of suitable slurries for use in the present invention include slurries comprising abrasive particles. Abrasives that can be used in the slurries include particulate cerium oxide, particulate alumina, particulate silica and the like. Examples of commercial slurries for use in the polishing of semiconductor substrates include but are not limited to ILD1200 and ILD1300 available from Rodel, Inc. Newark Del. and SemiSperse D-7000 and SemiSperse 12 available from Cabot Microelectronics Materials Division, Aurora, Ill.

In a non-limiting embodiment, the polishing pad of the present invention can be utilized with an apparatus for planarizing an article having a non-planar surface. The planarizing apparatus can include a retaining means for holding the article; and a motive power means for moving the pad and the retaining means with respect to the other such that movement of the pad and the retaining means causes the slurry and the planarizing surface of the pad to contact and planarize the non-planar surface of the article. In a further non-limiting embodiment, the planarizing apparatus can include a means of renewing the polishing or planarizing surface of the pad. A non-limiting example of a suitable renewing means includes a mechanical arm equipped with an abrasive disk which abrades the work surface of the pad.

In an alternative non-limiting embodiment, the planarizing apparatus can include an apparatus for conducting in-situ metrology of the article being polished or planarized. Commercial polishing or planarizing apparatuses are available from equipment manufacturers such as Applied Materials, LAM Research, SpeedFam-IPEC, and Ebara Corp.

In a non-limiting embodiment, the pad of the present invention can be placed on a cylindrical metal base; and can be connected to at least a portion of the base with a layer of adhesive. Suitable adhesives can include a wide variety of known adhesives. In a further non-limiting example, the pad can be placed on the cylindrical metal base or platen of a polishing or planarizing apparatus that includes a means of conducting in-situ metrology of the article being polished. The pad can be placed such that its window area can be aligned with the metrology window of the platen.

The present invention is more particularly described in the following examples, which are intended to be illustrative only, since numerous modifications and variations therein will be apparent to those skilled in the art. Unless otherwise specified, all parts and percentages are by weight.

### EXAMPLES

### Example A

Particulate crosslinked polyurethane was prepared from the ingredients listed in Table A. The particulate crosslinked polyurethane was used to prepare polishing pads as described further herein in Example 1.

TABLE A

| | |
|---|---|
| Ingredients | Weight (grams) |

Charge 1

| | |
|---|---|
| diamine curative (a) | 1050 |
| surfactant (b) | 31.5 |
| methyl isobutyl ketone solvent | 860 |

Charge 2

| | |
|---|---|
| isocyanate functional prepolymer (c) | 1570 |
| aliphatic polyisocyanate (d) | 446 |

(a) LONZACURE MCDEA diamine curative obtained from Air Products and Chemicals, Inc, which describes it as methylene bis(chlorodiethylanaline).
(b) PLURONIC F108 surfactant, obtained from BASF Corporation.
(c) ARITHANE PHP-75D prepolymer, obtained from Air Products and Chemicals, Inc, which describes it as the isocyanate functional reaction product of toluene diisocyanate and poly(tetramethylene glycol).
(d) DESMODUR N 3300A aliphatic polyisocyanate, obtained from Bayer Corporation, Coatings and Colorants Division, which describes it as a poly functional aliphatic isocyanate resin based on hexamethylene diisocyanate.

Charge 1 was added to an open container and warmed with stirring on a hot plate until the contents of the container reached 35° C. Stirring was continued at this temperature until the ingredients formed a homogeneous solution. The container was then removed from the hot plate. With stirring, Charge 2 was warmed to 55° C. using a water bath then added to Charge 1. The contents were mixed for two minutes with a motor driven impeller until the mixture was uniform. The contents of the container were then poured immediately into 10 kilograms of 30° C. deionized water, with concurrently vigorous stirring of the deionized water. Upon completion of the addition of the contents of the container, vigorous mixing of the deionized water was continued for an additional 30 minutes. The wet particulate crosslinked polyurethane was classified using a stack of sieves having mesh sizes from the top to the bottom of the stack of: 50 mesh (300 micron sieve openings), and 140 mesh (105 micron sieve openings). The isolated particulate crosslinked polyurethane particulate from the 140 mesh was dried overnight in a 80° C. oven.

### Example 1

A polishing pad comprising particulate crosslinked polyurethane and crosslinked polyurethane binder was prepared from the ingredients summarized in the following Table 1.

TABLE 1

| | |
|---|---|
| Ingredients | Weight (grams) |

Charge 1

| | |
|---|---|
| particulate crosslinked polyurethane | 2337 |
| of Example A | |

Charge 2

| | |
|---|---|
| isocyanate functional prepolymer (c) | 410.4 |
| aliphatic polyisocyanate (d) | 102.6 |
| catalyst (e) | 0.25 |
| acetone solvent | 120 |

(e) dibutyltin dilaurate 95%, obtained from Sigma-Aldrich Corporation.

Charge 2 was mixed using a motor driven stainless steel impeller until homogenous. The homogenous mixture of Charge 2 was then combined with Charge 1 in a suitable container and mixed together by means of a motor driven mixer until uniform. A 930 gram portion of the combination of Charges 1 and 2 was then introduced onto each of three 26″×26″ flat molds. The molds were fed through a pair of rollers at ambient temperature to form three sheets that were 0.100″ thick. The sheets were cured at 25° C. and 80% relative humidity for 18 hours followed by 130° C. for 1 hour. A double-coated film tape with release liner was applied to one surface of the cured sheets. The film tape was commercially obtained from 3M as type 442 double-coated film tape. Circular pads with a 20.0″ diameter were cut from the sheets. A window opening was then cut in each pad.

The shape of the opening was rectangular, having dimensions of 0.5″×2.0″, being positioned with the long axis radially oriented and centered 4″ from the center of the pad. The pad opening was sealed on the liner side with a 4″×4″ piece of 3M 442 double-sided tape. A spacer, constructed of 0.010″ polyester film, cut with dimensions to fit securely in the pad opening, was placed in the opening and firmly attached to the exposed adhesive of the 4″×4″ 3M 442 tape. A window resin was then prepared from the ingredients listed in Table 2.

TABLE 2

| | |
|---|---|
| Ingredients | Weight (grams) |

Charge 1

| | |
|---|---|
| diamine curative (a) | 6.8 |
| diamine curative (f) | 42.4 |
| processing aid (g) | 1 drop |

Charge 2

| | |
|---|---|
| aliphatic polyisocyanate (d) | 28.8 |

(f) VERSALINK P650 oligomeric diamine curative obtained from Air Products and Chemicals, Inc, which describes it as polytetramethylene ether glycol-diamine.
(g) COATOSIL 3501 additive obtained from OSi Specialties, which describes it as a defoamer.

Charge 1 was added to an open aluminum container and placed on a hot plate set at a temperature of 120° C. until the contents of the container became molten. The contents were thoroughly mixed with a stainless steel spatula until uniform. Charge 1 was then degassed to remove moisture and entrained air by placing the container in a vacuum oven set at 80° C. and pulling a vacuum of 1 mm to 5 mm Hg until bubbling ceased and any foaming subsided. The container was then removed from the vacuum oven, Charge 2 was added to Charge 1 and mixed with a spatula until uniform. The container was then placed in a second vacuum oven at ambient temperature and a 1 mm to 5 mm Hg vacuum was pulled for 5 minutes to remove any entrained air resulting from mixing.

The container of resin was then removed from the vacuum oven and a portion of the resin was carefully poured into the pad window openings with spacers so as not to introduce air voids into the resin. Sufficient resin was poured to bring the resin level flush with the upper pad surface. The resin was then allowed to cure overnight at ambient conditions. After curing, the 4″×4″ piece of 3M 442 double sided tape and the spacer were removed. The upper and lower surfaces of the pads were then made parallel with the window area being coplanar with the pad work surface using a milling machine.

### Example 2

A stacked pad was constructed by mounting the polishing pad assembly of Example 1 on a 22.0″ diameter SUBA IV subpad. To construct the pad, a window opening was first cut in the SUBA IV pad. The shape of the opening was rectangular, having dimensions of 0.5″×2.0″, being positioned with the long axis radially oriented and centered 4″ from the center of the pad. Next, the release liner of the polishing pad assembly of Example 1 was removed, exposing the adhesive. The polishing pad assembly was then firmly bonded, with this adhesive, to the SUBA IV subpad. Care was taken during mounting so that the window opening in the Suba IV subpad was aligned with the pad window.

### Example 3

Example 3 was prepared in the manner of Example 1 using window resin prepared from the ingredients listed in Table 3 using the following procedure.

TABLE 3

| | |
|---|---|
| Ingredients | Weight (grams) |

Charge 1

| | |
|---|---|
| polyamine curative (h) | 31.8 |
| processing aid (g) | 1 drop |

Charge 2

| | |
|---|---|
| epoxy resin (i) | 45.2 |

(h) VERSAMID 253 polyamine-polyamide curative, obtained from Cognis Corp.
(i) EPON 880 epoxy resin, obtained from Shell Chemical.

Charge 1 was added to an open aluminum container and the contents were thoroughly mixed with a stainless steel spatula until uniform. Charge 1 was then degassed to remove moisture and entrained air by placing the container in a vacuum oven set at 60° C. and pulling a vacuum of 1 mm to 5 mm Hg until bubbling ceases and any foaming subsides. The container was removed from the vacuum oven, Charge 2 was added to Charge 1 and mixed with a spatula until uniform. The container was then placed in a second vacuum oven at ambient temperature and a 1 mm to 5 mm Hg vacuum was pulled for 5 minutes to remove any entrained air resulting from mixing.

The container of resin was then removed from the vacuum oven and a portion of the resin was carefully poured into the pad window openings so as not to introduce air voids into the resin. Sufficient resin was pour to bring the resin level flush with the upper pad surface. The resin was then allowed to cure overnight at ambient conditions. After curing, the 4″×4″ piece of 3M 442 double-sided tape and the spacer were removed. The upper and lower surfaces of the pads were then made parallel with the window area being coplanar with the pad work surface using a milling machine.

### Example 4

Example 4 was prepared in the manner of Example 1 using window resin prepared from the ingredients listed in Table 4 using the following procedure.

TABLE 4

| | |
|---|---|
| Ingredients | Weight (grams) |

Charge 1

| | |
|---|---|
| acrylated oligamer (j) | 51.3 |
| acrylated oligamer (k) | 25.7 |
| processing aid (g) | 1 drop |

Charge 2

| | |
|---|---|
| initiator (l) | 1.1 |

(j) EBECRYL 8404 aliphatic urethane diacrylate, obtained from UCB Chemicals Corp.
(k) EBECRYL 4866 aliphatic urethane triacrylate, obtained from UCB Chemicals Corp.
(l) DAROCURE 1173 photoinitiator, obtained from Ciba Specialty Chemicals.

Charge 1 was added to an open aluminum container and the contents were thoroughly mixed with a stainless steel spatula until uniform. Charge 1 was then degassed to remove moisture and entrained air by placing the container in a vacuum oven set at 60° C. and pulling a vacuum of 1 mm to 5 mm Hg until bubbling ceases and any foaming subsides. The container was removed from the vacuum oven, Charge 2 was added to Charge 1 and mixed with a spatula until uniform. The container was then placed in a second vacuum oven at ambient temperature and a 1 mm to 5 mm Hg vacuum was pulled for 5 minutes to remove any entrained air resulting from mixing.

The container of resin was then removed from the vacuum oven and a portion of the resin was carefully poured into the pad window openings so as not to introduce air voids into the resin. Sufficient resin was pour to bring the resin level flush with the upper pad surface. The resin was then UV cured using a Fusion Systems D bulb. After curing, the 4″×4″ piece of 3M 442 double-sided tape and the spacer were removed, resulting in a suitable window area. The upper and lower surfaces of the pads were then made parallel with the window area being coplanar with the pad work surface using a milling machine. It was observed that upon manual flexing of the pad, the window broke away from the polishing pad.

### Examples 5-11

A sheet of polishing pad material comprising particulate crosslinked polyurethane and crosslinked polyurethane binder was prepared from the ingredients summarized in Table 1, using the procedure of Example 1. The sheet was then cured at a temperature of 25° C. and 80% relative humidity for 18 hours followed by 130° C. for 1 hour. 3M type 442 double coated film tape with release liner was applied to one surface of the cured sheet. Seven circular pads with a 3.2″ diameter were cut from the sheet. A window opening was then cut in each pad. The shape of the opening was rectangular, having dimensions of 0.5″×2.0″, being positioned with the center of the window located at the center of the pad. Each pad opening was then sealed on the liner side with adhesive tape. A spacer, constructed of 0.010″ polyester film, cut with dimensions to fit securely in the pad opening, was placed in the opening and firmly attached to the exposed adhesive of the tape. The window resin for Examples 5 through 1 was prepared in the manner of Example 1 from the ingredients listed in Table 2.

A portion of the resin was carefully poured into each pad window opening so as not to introduce air voids into the resin. Sufficient resin was poured to bring the resin level flush with the upper pad surface. The resin was then cured. The curing process consisted of allowing the pad assemblies to set for a specified time period at a specified temperature, as follows: Examples 5, 6, 7, 8, 9, 10 and 11 were cured at 22° C. for 18 hours, 45° C. for 6 hours, 65° C. for 4 hours, 85° C. for 2 hours, 105° C. for 1 hour, 125° C. for 1 hour and 145° C. for 1 hour, respectively.

After curing, the adhesive tape and the spacer were removed. The warp or buckling of the window was measured directly using a Mitutoyo Electronic Indicator, Model ID-C112EB mounted on a Mitutoyo Precision Granite Stand.

Before measurement, the window pads were equilibrated overnight at 22° C. and then Examples 5 through 11 were placed, one at a time, concave side up, on the granite stand. The indicator tip was placed on the window, 1-2 mm from the edge, and centered along one of the 0.5″ edges. The opposite 0.5″ edge was then depressed downward to contact the granite base and the deflection of the window due to warp was measured on the indicator. The warp was recorded in millimeters. The window warp recorded for Examples 5 though 11 was as follows.

| | Temperature | Time | Window Warp |
|---|---|---|---|
| Example 5 | 22° C. | 18 hrs. | 0.0 |
| Example 6 | 45° C. | 6 hrs. | 0.0 |
| Example 7 | 65° C. | 4 hrs. | 0.2 |
| Example 8 | 85° C. | 2 hrs. | 1.1 |
| Example 9 | 105° C. | 1 hr. | 1.3 |
| Example 10 | 125° C. | 1 hr. | 1.6 (window cracked |
| | | | during cure) |
| Example 11 | 145° C. | 1 hr. | 1.8 (window appeared |
| | | | distorted) |

We claim:

1. A polishing pad comprising a cast-in-place at least partially transparent window said window having a cure temperature of from 0° C. to less than 125° C.

2. The polishing pad of claim 1 wherein said polishing pad comprises a first layer and a second layer.

3. The polishing pad of claim 2 wherein said first layer comprises particulate polymer and an organic polymer binder.

4. The polishing pad of claim 2 wherein said second layer is chosen from substantially non-compressible polymers, metallic films and foils, and mixtures thereof.

5. The polishing pad of claim 4 wherein said second layer is chosen from polyolefins, cellulose-based polymers, acrylics, polyesters and co-polyesters, polycarbonates, polyamides, plastics, and mixtures thereof.

6. The polishing pad of claim 2 wherein said first layer is at least partially connected to said second layer.

7. The polishing pad of claim 2 further comprising a third layer.

8. The polishing pad of claim 7 wherein said third layer has a Shore A hardness lower than said first layer.

9. The polishing pad of claim 7 wherein said third layer has a percent volume compressibility greater than the first layer.

10. The polishing pad of claim 7 wherein said third layer is chosen from impregnated non-woven or woven fiber mat.

11. The polishing pad of claim 10 wherein said third layer is chosen from polyolefins, polyesters, polyamides, acrylic fibers and mixtures thereof.

12. The polishing pad of claim 7 wherein said third layer is chosen from natural rubbers, synthetic rubbers, thermoplastic elastomers, essentially resilient foam sheet, and mixtures thereof.

13. The polishing pad of claim 7 wherein said third layer is at least partially connected to said second layer.

14. The polishing pad of claim 1 wherein said window comprises a resin material.

15. The polishing pad of claim 14 wherein said resin material is chosen from polyurethane prepolymers with curative, epoxy resins with curative, ultraviolet curable acrylics, and mixtures thereof.

16. The polishing pad of claim 14 wherein said resin material is chosen from thermoplastic acrylic resins, thermoset acrylic resins, urethane systems, epoxy resins, polyester resins, and mixtures thereof.

17. The polishing pad of claim 14 wherein said resin material is chosen from hydroxyl-functional acrylic resins crosslinked with urea-formaldehyde or melamine-formaldehyde resins, hydroxyl-functional acrylic resins crosslinked with epoxy resins, or carboxyfunctional acrylic resins crosslinked with carbodiimides or polyimines or epoxy resins, hydroxyfunctional acrylic resins crosslinked with polyisocyanate, diamine cured isocyanate-terminated prepolymers, isocyanate-terminated prepolymers crosslinked with polyamines, amine-terminated resins crosslinked with polyisocyanates, carbamate-functional acrylic resins crosslinked with melamine-formaldehyde resins, polyamide resin crosslinked with bisphenol A epoxy resins, phenolic resins crosslinked with bisphenol A epoxy resins, hydroxyl-terminated polyesters crosslinked with melamine-formaldehyde resins or with polyisocyanates or with epoxy crosslinkers, and mixtures thereof.

18. The polishing pad of claim 14 wherein said resin material comprises amine-terminated oligomer, diamine, and polyisocyanate.

19. The polishing pad of claim 1 wherein said window is at least partially transparent to at least one wavelength in the range of from 190 to 3500 nanometers.

20. The polishing pad of claim 1 wherein said cure temperature is from 5° C. to 120° C.

21. The polishing pad of claim 1 wherein said cure temperature is from 10° C. to 115° C.

22. The polishing pad of claim 1 wherein said cure temperature is from 15° C. to 110° C.

23. The polishing pad of claim 1 wherein said cure temperature is from 22° C. to 105° C.

24. A method for producing a polishing pad comprising an at least partially transparent window, comprising the steps of:
a. forming a polymer-containing first layer;
b. forming a second layer which is less compressible than the first layer;
c. at least partially connecting said first layer to said second layer;
d. producing an opening into said first layer;
e. producing an opening into said second layer;
f. at least partially aligning said opening in said first layer and said opening in said second layer;
g. inserting a spacer into said opening;
h. filling opening above said spacer with a resin material; and
i. allowing said resin material to cure at a temperature of from 0° C. to less than 125° C.

25. The method of claim 24 further comprising the step of:
j. removing said spacer.

26. The method of claim 24 wherein said second layer is chosen from polyolefins, cellulose-based polymers, acrylics, polyesters and co-polyesters, polycarbonates, polyamides, plastics, and mixtures thereof.

27. The method of claim 24 further comprising the steps of forming a third layer; producing an opening into said third layer; at least partially connecting said third layer to said second layer; and at least partially aligning said opening of said first layer, said opening of said second layer and said opening of said third layer.

28. The method of claim 24 wherein said resin material is chosen from polyurethane prepolymers with curative, epoxy resins with curative, ultraviolet curable acrylics, and mixtures thereof.

29. The method of claim 24 wherein said window is at least partially transparent to wavelengths in the range of from 190 to 3500 nanometers.

30. The method of claim 24 wherein in step h, an amount of resin is used to fill said spacer such that said resin is flush with a polishing surface of said first layer.

31. The method of claim 24 wherein in step i said temperature for cure is from 5° C. to 120° C.

32. The method of claim 24 wherein in step i said temperature for cure is from 10° C. to 115° C.

33. The method of claim 24 wherein in step i said temperature for cure is from 15° C. to 110° C.

34. The method of claim 24 wherein in step i said temperature for cure is from 22° C. to 105° C.

35. A polishing pad having an at least partially transparent window wherein formation of said window comprises forming a first layer and a second layer, at least partially connecting said first layer to said second layer;
producing an opening into said first and second layers such that said opening in said first layer at least partially aligns with said opening in said second layer; inserting a spacer into said opening; filling opening above said spacer with a resin material; allowing said resin material to cure at a temperature of from 0° C. to less than 125° C., and removing said spacer.
